(19) United States
(12) Patent Application Publication
(10) Pub. No.: US 2004/0206213 A1
(43) Pub. Date: Oct. 21, 2004

(54) Wrench having a holding structure

(76) Inventor: Chih-Ching Hsien, Taichung (TW)

Correspondence Address: Chih-Ching Hsien, 58, MA YUAN WEST ST., TAICHUNG, TW

(21) Appl. No.: 10/418,997

(22) Filed: Apr. 18, 2003

(51) Int. Cl. B25B 13/00

(52) U.S. Cl. 81/125.1

(57) ABSTRACT

A wrench having a holding structure includes a handle having a mediate section formed with a distorted portion, and an anti-skid rubber jacket coated on the distorted portion of the handle to enhance the holding force on the wrench. Thus, the anti-skid rubber jacket coated on the distorted portion of the handle can enhance the holding force of the user's thumb, thereby preventing the user's thumb from slipping due to the grease attached on the surface of the wrench.

### BACKGROUND OF THE INVENTION

1. Field of the Invention

The present invention relates to a wrench having a holding structure, and more particularly to a wrench having a holding structure, wherein the anti-skid rubber jacket coated on the distorted portion of the handle can enhance the holding force of the user's thumb, thereby preventing the user's thumb from slipping due to the grease attached on the surface of the wrench.

2. Description of the Related Art

A conventional wrench in accordance with the prior art shown in FIG. 5 comprises a handle 21 having a first end formed with an open drive portion 23 and a second end formed with a closed head portion 22. The open drive portion 23 has two sides each formed with a size portion 24. The handle 21 has a mediate section formed with a bent driving portion 25. In operation, when the open drive portion 23 is used to rotate a workpiece 30 on a surface “A”, the size portion 24 directly touches the surface “A”, so that the size portion 24 is easily worn out due to the rubbing action, thereby causing inconvenience to the user in identifying the size of the wrench. In addition, the handle 21 has a smooth surface, thereby decreasing the holding force of the user's thumb, so that the user's thumb easily slips from the bent driving portion 25 due to the grease attached on the surface of the handle 21 of the wrench. Further, the size portion 24 is printed on the open drive portion 23, so that the user cannot easily identify the size of the wrench when it is very small.

### SUMMARY OF THE INVENTION

The primary objective of the present invention is to provide a wrench having a holding structure, wherein the anti-skid rubber jacket coated on the distorted portion of the handle can enhance the holding force of the user's thumb, thereby preventing the user's thumb from slipping due to the grease attached on the surface of the wrench.

Another objective of the present invention is to provide a wrench having a holding structure, wherein the anti-skid rubber jacket coated on the distorted portion of the handle can provide an anti-skid effect.

A further objective of the present invention is to provide a wrench having a holding structure, wherein the anti-skid rubber jacket has a color formed thereon, so that the user can identify if the size of the wrench is a metric system or a British system easily and rapidly.

A further objective of the present invention is to provide a wrench having a holding structure, wherein when the wrench is used to operate the workpiece, the size indication portion does not directly contact the surface of the workpiece, thereby preventing the size indication portion from being worn out due to the rubbing action, so that the size indication portion can clearly indicate the size of the wrench to facilitate the user's employment.

A further objective of the present invention is to provide a wrench having a holding structure, wherein the anti-skid rubber jacket is made of plastic material, thereby saving costs of fabrication.

A further objective of the present invention is to provide a wrench having a holding structure, wherein the anti-skid rubber jacket can be formed and machined easily and conveniently, thereby saving costs of fabrication.

In accordance with the present invention, there is provided a wrench, comprising:

a handle having a mediate section formed with a distorted portion; and

an anti-skid rubber jacket coated on the distorted portion of the handle to enhance the holding force on the wrench.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wrench having a holding structure in accordance with the preferred embodiment of the present invention;

FIG. 2 is a perspective view of the wrench having a holding structure in accordance with the preferred embodiment of the present invention;

FIG. 3 is a plan view of the wrench having a holding structure as shown in FIG. 2;

FIG. 4 is a schematic operational view of the wrench having a holding structure as shown in FIG. 1 in use; and

FIG. 5 is a perspective operational view of a conventional wrench in accordance with the prior art.

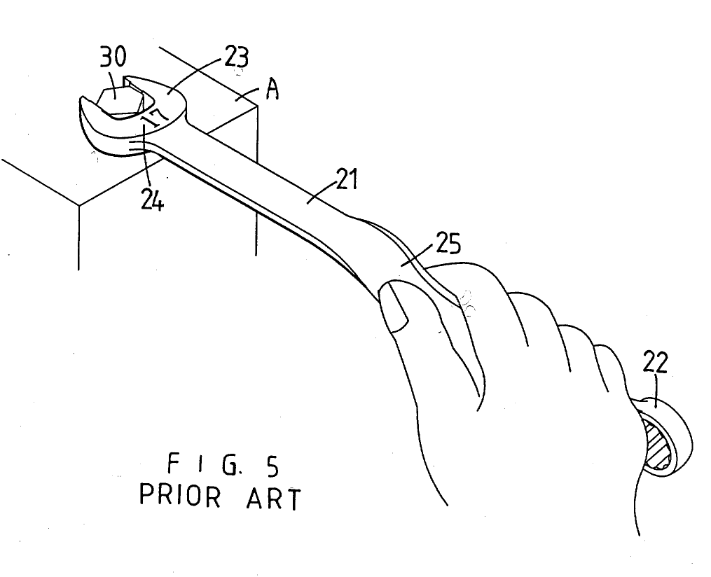

### DETAILED DESCRIPTION OF THE INVENTION

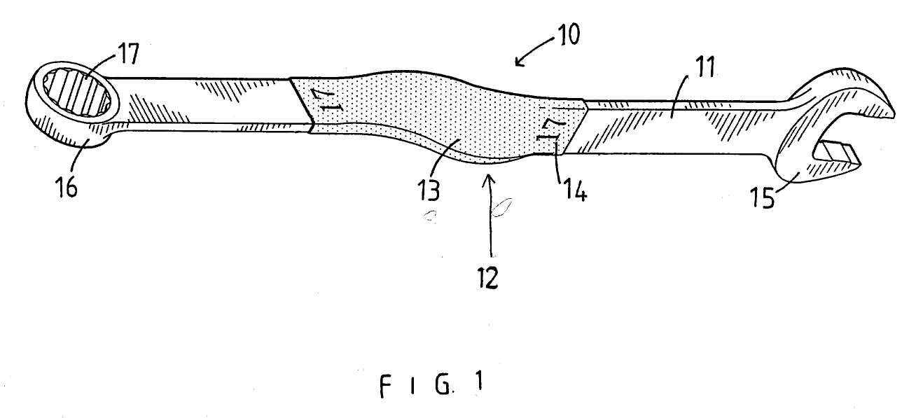

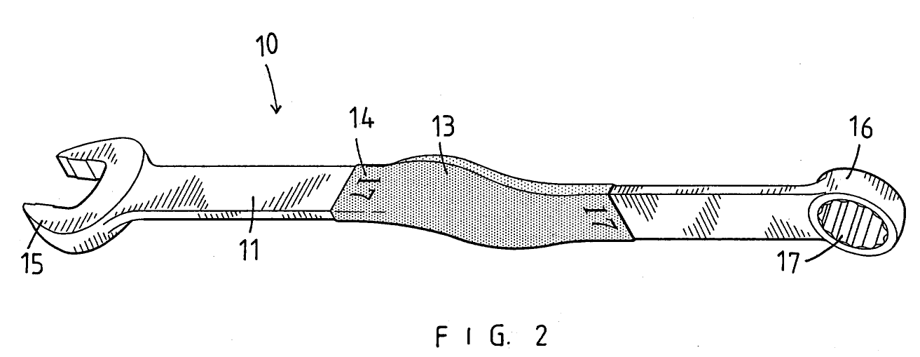

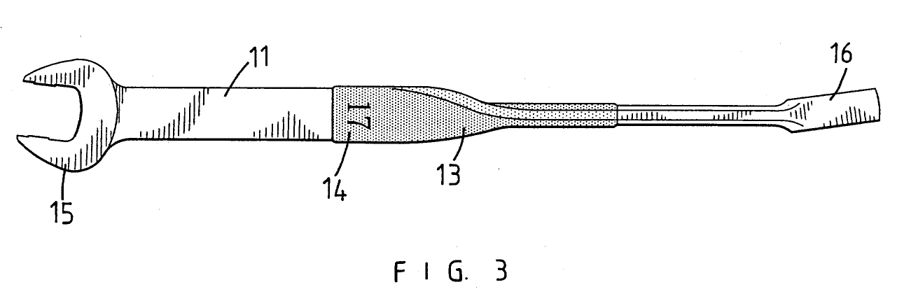

Referring to the drawings and initially to FIGS. 1-3, a wrench 10 having a holding structure in accordance with the preferred embodiment of the present invention comprises a handle 11 having a first end formed with an open drive portion 15 and a second end formed with a closed head portion 16 having an inner wall formed with a plurality of teeth 17.

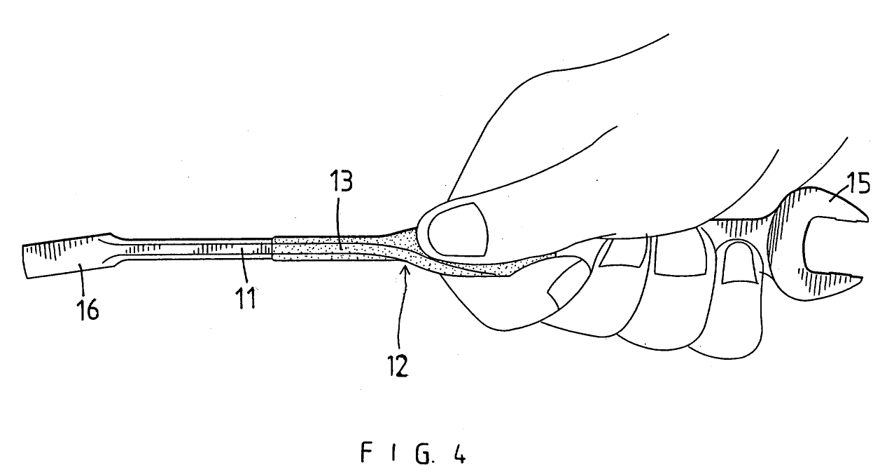

The handle 11 has a mediate section formed with a distorted portion 12. The distorted portion 12 of the handle 11 has a configuration matching a user's thumb as shown in FIG. 4, thereby facilitating the user operating the handle 11 to rotate a workpiece (not shown), such as the nut, bolt or the like. In addition, the distorted portion 12 of the handle 11 has two ends vertical to each other.

The wrench 10 further comprises an anti-skid rubber jacket 13 coated on the distorted portion 12 of the handle 11. The anti-skid rubber jacket 13 has a color formed thereon. The anti-skid rubber jacket 13 is formed with a size indication portion 14 which is printed on the anti-skid rubber jacket 13 in a press manner.

Thus, when the wrench 10 is used to operate the workpiece, the size indication portion 14 does not directly contact the surface of the workpiece, thereby preventing the size indication portion 14 from being worn out due to the rubbing action, so that the size indication portion 14 can clearly indicate the size of the wrench 10 to facilitate the user's employment.

In addition, the anti-skid rubber jacket 13 has a color formed thereon, so that the user can identify if the size of the wrench 10 is a metric system or a British system easily and rapidly.

Further, the anti-skid rubber jacket 13 can enhance the holding force of the user's thumb, thereby preventing the user's thumb from slipping due to the grease attached on the surface of the wrench 10.

In fabrication, the wrench 10 is formed by forging. Then, the handle 11 of the wrench 10 is bent and distorted by a machining tool to form the distorted portion 12. Then, the wrench 10 is immersed into a container full of colorful rubber material. Then, the wrench 10 is removed from the container. After the colorful rubber material coated on the whole wrench 10 is dried, the colorful rubber material on the two ends of the distorted portion 12 of the handle 11 is cut off, thereby forming the anti-skid rubber jacket 13 coated on the distorted portion 12 of the handle 11.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wrench, comprising:
a handle having a mediate section formed with a distorted portion; and
an anti-skid rubber jacket integrally coated on the distorted portion of the handle to enhance the holding force on the wrench, wherein:
the anti-skid rubber jacket has a surface flush with that of the distorted portion of the handle.

2. The wrench in accordance with claim 1, wherein the handle has a first end formed with an open drive portion and a second end formed with a closed head portion having an inner wall formed with a plurality of teeth.

3. The wrench in accordance with claim 1, wherein the anti-skid rubber jacket on the distorted portion of the handle has a configuration to accommodate a user's-thumb, thereby facilitating the user operating the handle.

4. The wrench in accordance with claim 1, wherein the distorted portion of the handle has two ends vertical to each other.

5. The wrench in accordance with claim 1, wherein the anti-skid rubber jacket has a color formed thereon so that a user can identify a size system of the wrench.

6. The wrench in accordance with claim 1, wherein the anti-skid rubber jacket is formed with a size indication portion at two opposite sides thereof.

7. The wrench in accordance with claim 1, wherein the wrench is immersed into a container full of colorful rubber material, is then removed from the container to be dried, and the colorful rubber material on the two ends of the distorted portion of the handle is then cut, thereby forming the anti-skid rubber jacket coated on the distorted portion of the handle.
